(19) United States
(12) Patent Application Publication
(10) Pub. No.: US 2014/0297488 A1
(43) Pub. Date: Oct. 2, 2014

(54) Method for handling refunds in a budgeting system

(71) Applicant: Ryan Caldwell, Provo, UT (US)

(72) Inventor: Ryan Caldwell, Provo, UT (US)

(73) Assignee: MonyDesktop, Inc.

(21) Appl. No.: 13/573,357

(22) Filed: Sep. 11, 2012

(51) Int. Cl. G06Q 40/00

(52) U.S. Cl. CPC G06Q 40/12
USPC 705/30

(57) ABSTRACT

A method, system and computer software are provided that allows a user to process refunds in order to correctly calculate cash flow and to display it in a meaningful manner to a user.

### BACKGROUND

In the prior art, there have been many computer software packages to perform personal budgeting functions. Those packages can accurately track a user's income and expenses compared to a prepared budget, allowing to monitor when expenses approach or exceed a budgeted maximum.

A fault with each of those prior art packages is that refunds are either ignored entirely or not represented in a meaningful way. Refunds are not new income, so they do not fall into the income category. Refunds are not expenses, so they do not properly fall into the expense category. Therefore it is common practice for prior art personal budgeting software packages to simply ignore refunds. This is a problem because it causes a divergence between actual cash on hand (bank account balances) and the traditional calculation of income minus expenses.

### SUMMARY

A method has been invented to accommodate negative budgeting. This method can be referred to as a method or system for handling refunds in a personal budgeting system.

In addition to properly calculating and properly categorizing refunds, a novel mechanism for displaying refunds in graphical format has been invented. These and other features of the invention will become clear upon persons of ordinary skill in the art upon reading this document in light of the appended drawings.

### BRIEF DESCRIPTION OF DRAWINGS

The embodiments of the invention are illustrated by way of example, and not by way of limitation, in the figures of the accompanying drawings.

FIGS. 1a-1d generally depicts how refunds may be handled in a budgeting system.

FIG. 2 depicts a spending category against which rules of budgeting may be discussed in conjunction with refund handling.

FIG. 3 provides a description of proposed calculation rules that can be followed when using the invention.

### DETAILED DESCRIPTION

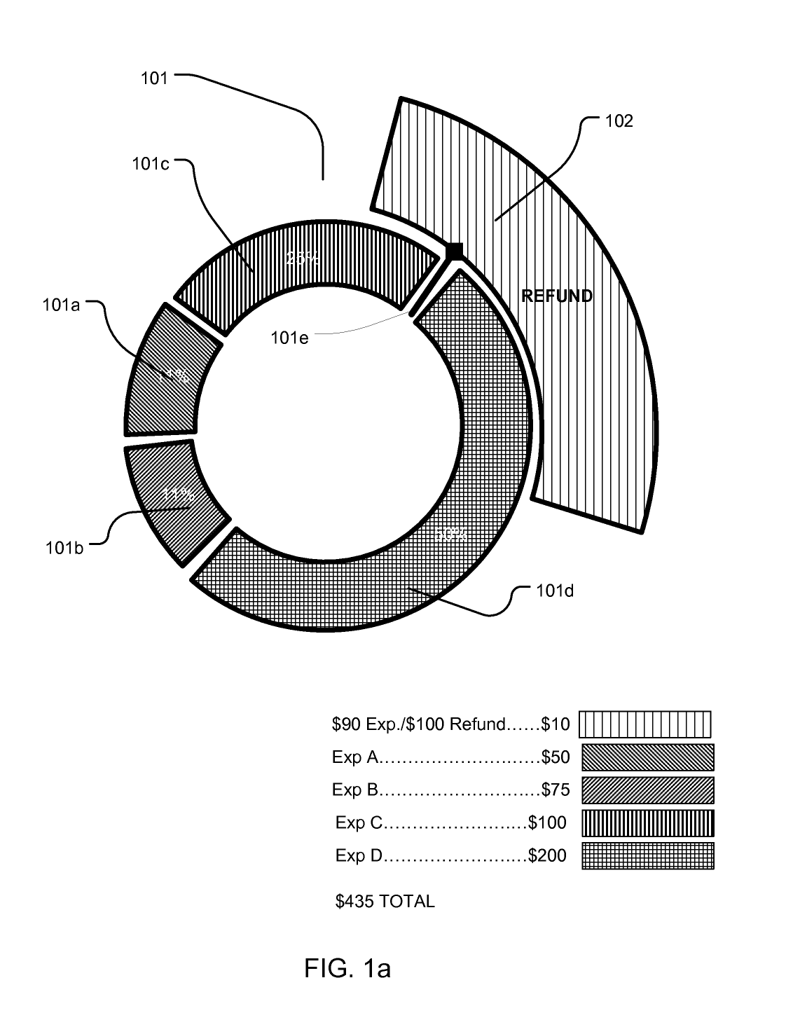

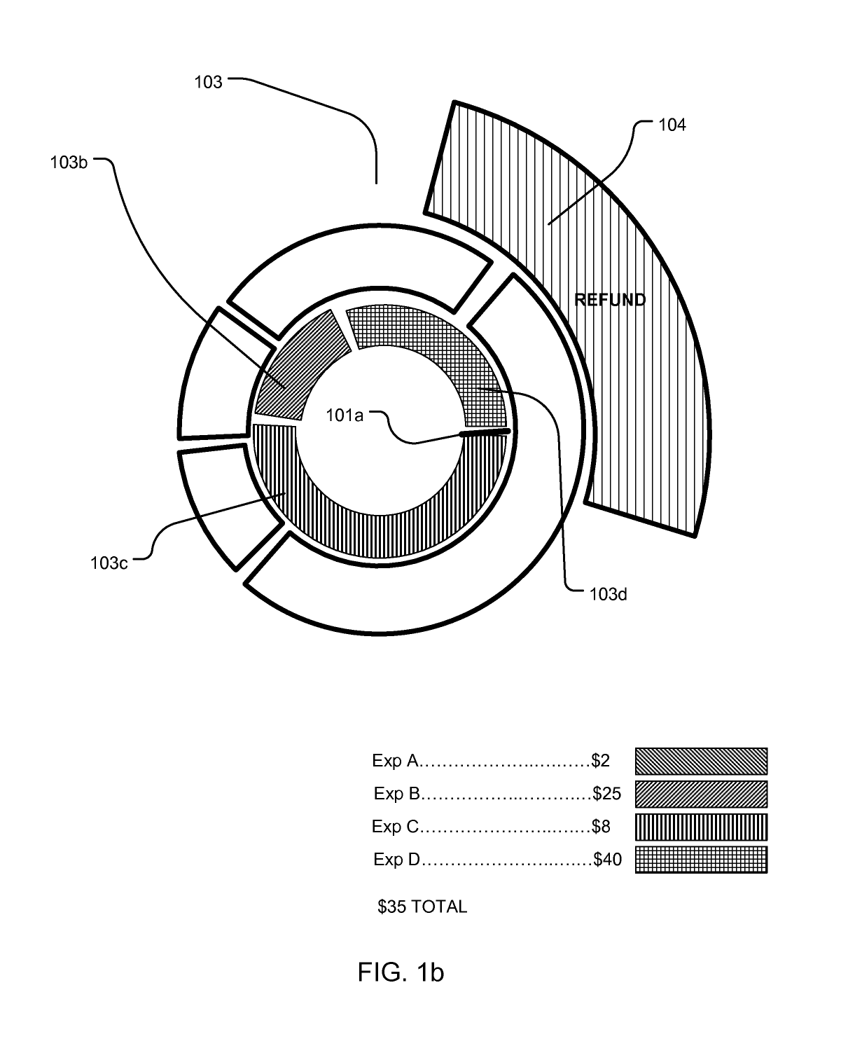

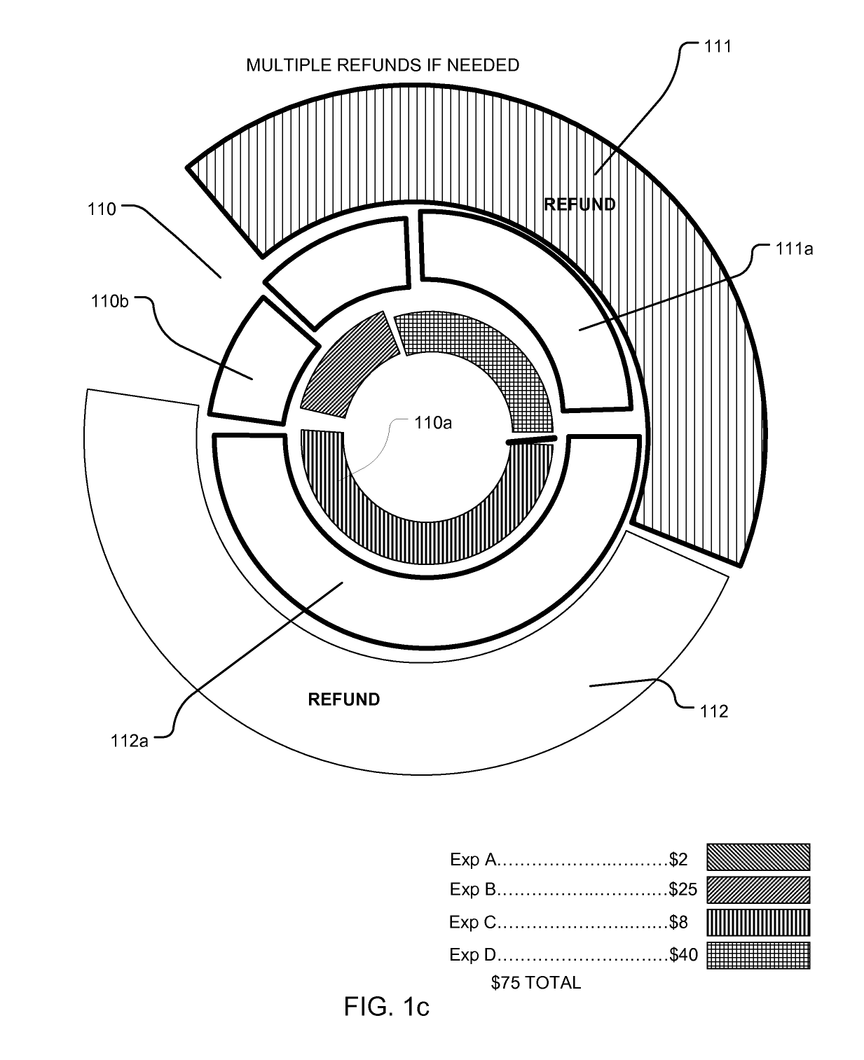

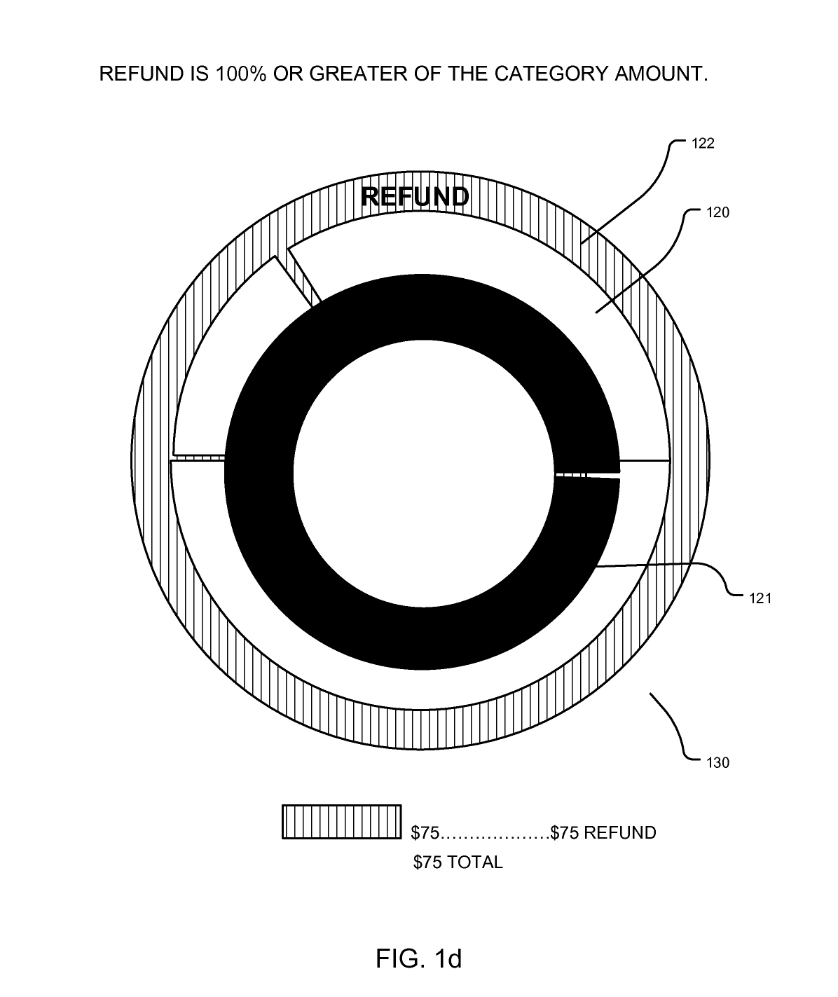

The invention can be implemented as software that runs on a digital computer. The state of technology and trends as of the time of writing this document indicates that digital computers running software will be a preferred implementation for many years to come. For the purposes of this document, the term “digital computer” includes desktop computers, laptop computers, tablet computers, hand-held mobile electronic devices (including so-called smart phones), other mobile electronic devices, networked computers, mainframe computers, and other computing devices. Other computing devices may include analog computing devices, quantum computing devices, biological computing devices and other computing devices. Although the invention can be implemented as software operating on a computing device, the invention can also be implemented as firmware or it may be implemented in hardware or otherwise as desired. Such implementations are intended to be within the scope of the invention. Commonly a computing device for using the invention will include a display device such as a screen or other image on which information can be displayed to a user, an input device through which a user can control the computing device, and a processor for carrying out computations as required by the invention. The computing device may also include a means for carrying wireless transmission and receipt of data, dynamic memory, static memory, a power source such as a battery, and other features. In the field of personal financial management (“PFM”), it is desirable to provide budgeting systems which allow users to budget for and track their income and expenses. The reasons why budgeting is desirable are omitted from this document. However, assuming that a user wishes to prepare and track a budget, then the invention provides clear advantages in being able to computationally handle and visually display refunds in a manner that it is intuitive, understandable and useful to users Referring to FIG. 1a, a graphical representation of a budget category known as a spending pie or spending wheel 101 is depicted. In this example, the spending wheel 101 depicts four expenses. These are Expense A for $50 depicted as 101a. Expense B for $75 depicted as 101b. Expense C for $100 depicted as 101c. Expense D for $200 depicted as 101d. The figure also shows the refund 101e. The refund is denoted by a refund label 102. The refund label 102 not only points to the portion of the spending wheel representing the refund, it also spans an arc of the circular spending wheel 101 in tab or label form to draw a user's attention to the refund that has been processed. In this case there was a $90 expense that resulted in a $100 refund, giving a $10 absolute value of the difference between the two which is indicated by the refund section 101e of the spending pie. The size of the refund label 102 may be based on the size of the refund, or it may be an arbitrary fixed size to enhance viewability of the graphic images used on the user's display. As desired, portions of the spending wheel and the refund label may be colorized or texturized so that each item is readily distinguishable from each other item. Multiple refund labels can be displayed in the event of multiple refunds, and they can be sized for viewability.

The spending wheel 101 depicted is for a parent category of expenses, such as “Automobile and Transportation”. That parent category may have many child categories such as automobile payment, airline tickets, gasoline expenses, automobile repairs, automobile insurance, etc. In a spending wheel such as this, the total circle or spending wheel is made up of the absolute values of the parent categories (such as Expense A, Expense B, etc.). The refund label points to the refund section of the parent category which takes up space equal to the absolute value of the refund credit which results from the refund. The gross amount of the refund may be indicated numerically or by the size of the refund label as desired.

Referring to FIG. 1b, a child category of FIG. 1a is depicted. The child category corresponds to Expense B ($75) from FIG. 1a. For this example, we will assume that the child category is for gasoline expenses. For the child category, there is a spending wheel 103 that depicts sections for expenses in the child category, namely Expense A 103a, Expense B 103b, Expense C 103c, and the refund 103d. The refund has a refund label 104 which both points to it and spans an arc of the spending wheel to draw attention to the refund. Within the child category, the total circle or spending wheel is made up of the absolute values of the spending categories (in this case, the $25 refund is calculated as being positive in calculating its dimension on the spending wheel). The refund label points to the parent category that it refers to and has a size equal to the absolute value of the credit caused by the refund.

As a general note, the outer ring can represent the parent category and the inner ring can represent the child budget, or vice versa, thus providing the user with information pertaining to both.

Referring to FIG. 1c, a graphical depiction is provided to exemplify how multiple refunds can be displayed. In this example, a spending wheel 110 is graphically depicted as a circle with a hollow or empty center. The inner ring 110a of the spending wheel depicts the child category budget items and the outer wheel 110b depicts the parent category budget items. Each section of the parent and child rings can be sized based on their respective dollar magnitudes. A refund label 111 and a refund label 112 are shown to indicate that two refunds have occurred, one corresponding to expense 111a and one corresponding to expense. Each refund label both points to the expense that it relates to and spans an arc of the spending wheel. The relative sizes of the refund labels may be set based on the relative size of their respective dollar amounts, or they may be an arbitrary size for viewing ease. It is possible to handle multiple refunds, rather than just two, and if needed the refund labels can overlap each other. In a busy budget category with many refunds, the refund labels could be stacked on top of each other, or stacked with a small edge protruding so that the user can see that there are multiple refunds.

Referring to FIG. 1d, a spending wheel 130 is depicted that has a parent category 120, a child category 121 and a refund 122 relating to an expense in the child category. In this case the refund is greater than the total amount of the child category, causing the refund label to span the entire spending wheel. It may be desirable to make the refund label smaller and consistent with the size and shape of refund labels in other budget categories.

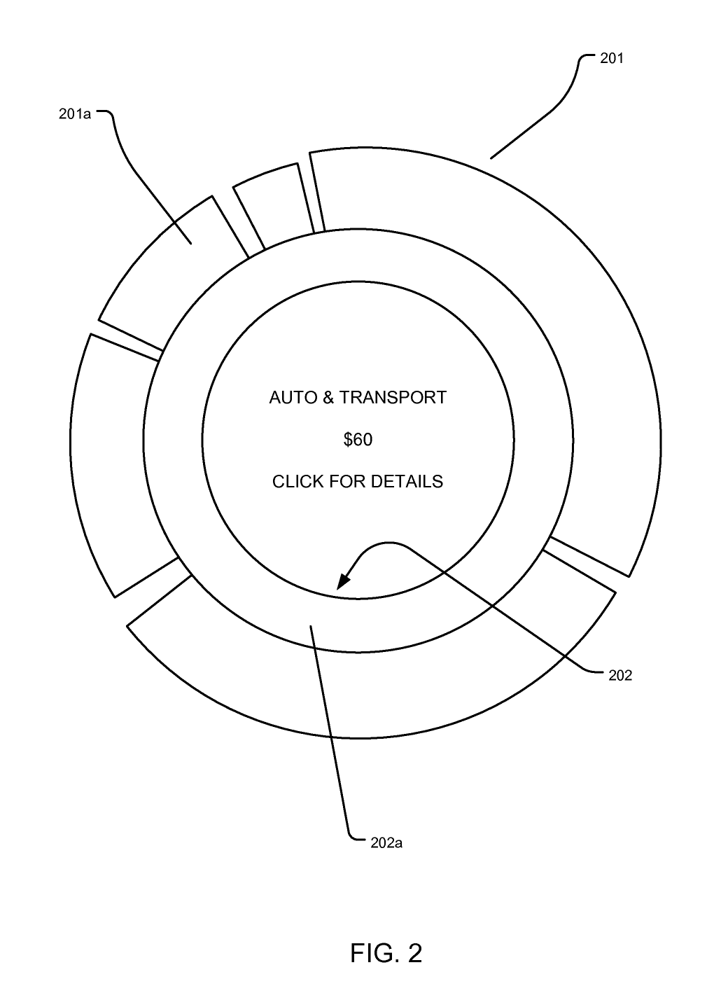

Referring to FIG. 2, an example spending wheel in the Auto & Transport category is depicted: The figure shows the parent spending wheel 201 and the child spending wheel 202. The parent spending wheel has a budget portion 201a which corresponds to the Auto & Transport child 202. In this example, there was a $60 general expense 202a and a gas expense (refund) of $−43.69.

As a general matter, a debit will be considered an expense, which is a positive number in the spending wheel. A credit is a refund which is a negative number in the spending wheel.

There are 3 primary rules to consider using when carrying out refund calculations using the invention.

Rule 1: The spending wheel cannot have a negative number. In other words, if a category of a spending wheel contains a refund (such as product return, rebate, etc.) then it will only be displayed if the refund exceeds the expenses in the category. In the case of a parent, if a parent is negative it will not display its children even though they are positive. And in the case of a child, if a child is negative, it will not be displayed within the parent.

Rule 2: If the sum of a category is positive, then the parent/child segment will display the sum in the wheel. For example, If there were $100 in expenses with $90 in returns, then $10 would be shown on the spending wheel.

Rule 3: If the sum of a category is positive then the parent/child will display all the positive and negative transactions in the list. For example, if there is $100 in expenses with $90 in refunds show a credit of $10.

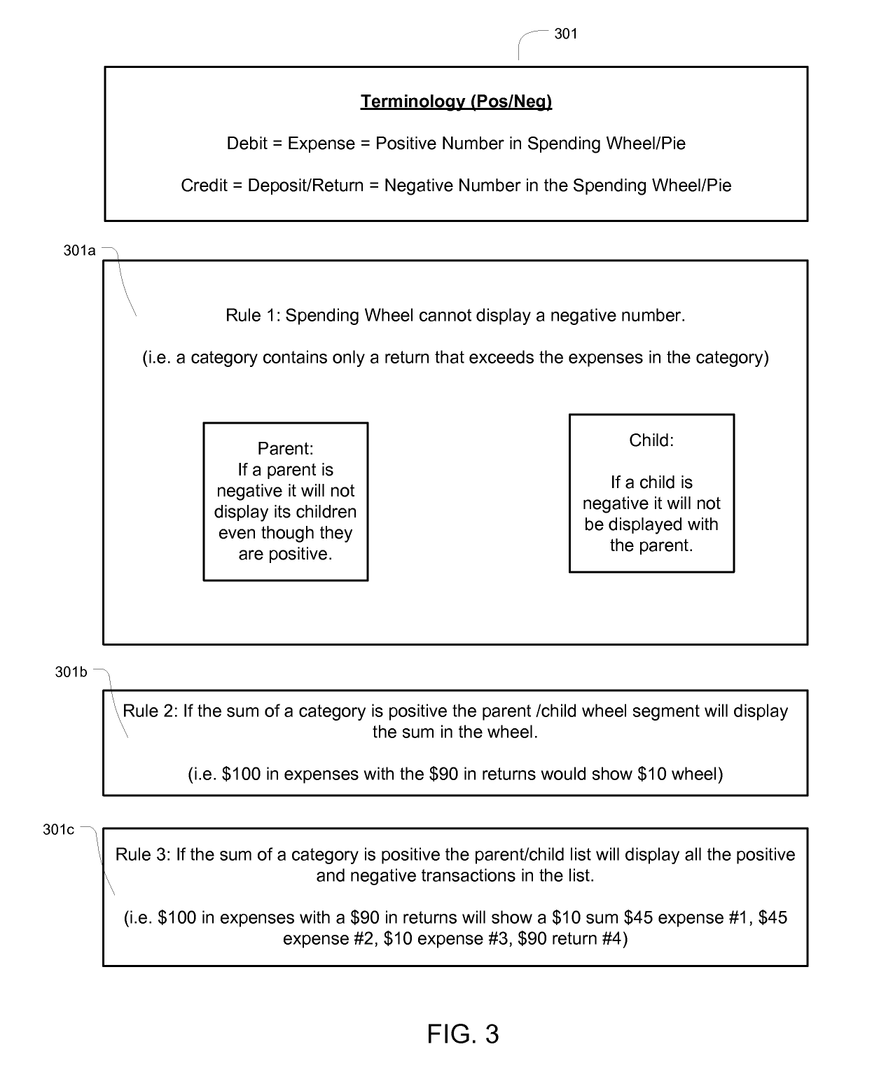

Referring to FIG. 3, these rules 301 are depicted with rule 1 being represented as 301a, rule 2 being represented as 301b and rule 3 being represented as 301c.

[As another example, consider the situation where a person received a refund of $7000 from their mortgage company this month. That person also had $800 in utility expenses, so they have a Home parent category expense of −$6200. To fully inform the user of a budgeting impact of this information, the software needs a way to show both the utility expense and the refund. When the total parent refund is less than the parent expense, then this is not an issue as the software simply shows the expense minus the refund. However, when the refund is more than the expense it is necessary to show the refund minus the expense. This provides a refund tag that hovers over that slice of the spending wheel. Any time the user drills into a parent category, then any child that is a refund will show with a refund tag if it also meets the above criteria.

Continuing the above example, if the total household expenses for the month, including the $800 in utility expenses, are $10,000, and the refund is still $7,000 then the total Home expenses are $800 from the utilities category and $7,000 in the mortgage category, then the total pie would represent $15,400 with $6200 making up the Home parent with a refund tag hovering over it. When the user clicks on the Home parent, the children show up as a $7,000 Mortgage child with a “REFUND” in its line item, and a refund tag on the spending pie, and a minus sign beside the $7,000 refund (or some other representation that it is a negative amount in the budget) so that its total with the $800 in utilities expense is $−6200. This figure will represent the size of the parent in the parent pie.

While the present invention has been described and illustrated in conjunction with a specific embodiment, those skilled in the art will appreciate that variations and modifications may be made without departing from the principles of the invention as herein illustrated, described, and claimed. The present invention may be embodied in other specific forms without departing from its spirit or essential characteristics. The described embodiment is to be considered in all respects as only illustrative, and not restrictive. The scope of the invention is, therefore, indicated by the appended claims, rather than by the foregoing description. All changes which come within the meaning and range of equivalency of the claims are to be embraced within their scope.

1. A method for budgeting refunds in a personal budgeting computer program comprising the steps of:
establishing a budget having a parent budget category and at least one child budget category,
accepting expense figures for both said parent and said child categories,
accepting at least one refund figure for said child category,
calculating a child category total expense amount based on all expenses and all refunds in said child category,
creating a child category spending wheel based on said child category total expense amount,
said child category spending wheel having a proportionately-sized region for each child category expense and for each child category refund,
displaying said child category spending wheel on a display device,
creating a refund label for each of said refund figures,
displaying said refund label(s) adjacent said child category refunds on said child category spending wheel,
creating a parent category spending wheel based at least in part on said child category total expense amount, and
displaying said parent category spending wheel on a display device.

2. A method as recited in claim 1 wherein said refund label points to a refund amount shown on said child category spending wheel.

3. A method as recited in claim 1 wherein said refund label points to a refund amount shown on said parent category spending wheel.

4. A method as recited in claim 1 wherein said child category spending wheel is displayed on said display device inside said parent category spending wheel.

5. A method as recited in claim 1 wherein multiple refund labels are displayed adjacent each other on said display device.

6. A method as recited in claim 1 wherein multiple refund labels are stacked on said display device.

7. A method as recited in claim 6 wherein multiple refund labels are stacked with an edge of each refund label being visible on from said stack said display device to that a user can perceive multiple refund labels on said display device.

8. A method as recited in claim 1 wherein said expense wheels are sized based on absolute values of total expenses and refunds.

9. A method as recited in claim 1 wherein said each expense and each refund on a spending wheel is colorized to distinguish it from other expenses and refunds on the same spending wheel.

10. A method for displaying refunds in a personal budgeting computer program comprising the steps of:
creating a spending wheel that visually represents various expenses and at least one refund for a desired period of time,
said spending wheel visually representing each of several expense items in a generally circular fashion,
said spending wheel visually representing said refund adjacent said expense items,
creating a refund tag that visually represents said refund, said refund tag being adjacent to said refund on said spending wheel, and
displaying said spending wheel and refund tag on a computer display device so that a user may view it.

11. A method as recited in claim 10 wherein said expense items and said refund item are entered by a user.

12. A method as recited in claim 10 wherein said spending wheel has a proportionately-sized region for each expense.

13. A method as recited in claim 10 wherein said spending wheel has a proportionately sized region for each refund.

14. A method as recited in claim 10 further comprising the step of creating a parent expense wheel and a child expense wheel.

15. A method as recited in claim 14 further comprising the step of displaying said child expense wheel within said parent expense wheel on said display device.

16. A method as recited in claim 1 wherein said refund tag points to said refund on said spending wheel.

17. A method as recited in claim 10 wherein multiple refund labels are displayed adjacent each other on said display device.

18. A method as recited in claim 10 wherein multiple refund labels are stacked on said display device.

17. A method as recited in claim 10 wherein multiple refund labels are stacked with an edge of each refund label being visible on from said stack said display device to that a user can perceive multiple refund labels on said display device.
